(19) United States
(12) Patent Application Publication
(10) Pub. No.: US 2021/0119364 A1
(43) Pub. Date: Apr. 22, 2021

(54) FEMALE CONNECTOR FOR A RELAY

(71) Applicant: Phoenix Contact GmbH & Co.KG, Blomberg (DE)

(72) Inventor: Ralf Hoffmann, Berlin (DE)

(21) Appl. No.: 17/057,022

(22) PCT Filed: May 21, 2019
(86) PCT No.: PCT/EP2019/063058

§ 371 Date: Nov. 19, 2020

(30) Foreign Application Priority Data
May 25, 2018 (BE) BE2018/5336

(51) Int. Cl. H01R 13/11; H01R 31/06; H01R 13/24; H01R 13/66

(52) U.S. Cl. CPC H01R 13/111; H01R 13/665; H01R 13/2428; H01R 31/065

(57) ABSTRACT

A female connector for a relay includes a housing, a contact wall, and a spring tongue. The contact wall is arranged in the housing, and has a first deformation with at least one first contact elevation. The spring tongue is arranged in the housing, facing the contact wall, and has a second deformation having a plurality of second contact elevations. A dip is formed between two successive second contact elevations, and the second contact elevations are arranged opposite the at least one first contact elevation. The second contact elevations are configured to press contact pins of different lengths against the at least one first contact elevation in sprung manner.

### CROSS-REFERENCE TO RELATED APPLICATIONS

The present application is the national phase entry under 35 U.S.C. 371 of International Patent Application No. PCT/EP2019/063058 by Hoffmann, entitled “FEMALE CONNECTOR FOR A RELAY,” filed May 21, 2019; and claims the benefit of Belgian Patent Application No. BE2018/5336 by Hoffmann, entitled “BUCHSENSTECKER FUER EIN RELAIS,” filed May 25, 2018, each of which is assigned to the assignee hereof and is incorporated by reference in its entirety.

### FIELD OF THE DISCLOSURE

The present disclosure relates to a female connector, and more particularly to a female connector for use with a narrow relay.

### BACKGROUND

For electrical contacting of contact pins of a relay, female connectors are usually used, which are adapted as so-called tulip contacts. Such tulip contacts have flat-form springs which are arched in a flat shape and which are provided to generate the contact force on a contact pin inserted into the female connector.

Due to the curvature of the flat-form springs, however, a large installation space is required for the female connector. In addition, a large width of the flat-form spring is required to generate the contact force, which limits the arrangement density of the female connector in, for example, a terminal block.

### SUMMARY

It is therefore the object of the present disclosure to provide an improved female connector for a relay.

This object is achieved by the features of independent claims 1 and 19.

Advantageous examples and implementations of these features are the subject matter of the dependent claims, the description and the accompanying figures.

According to one aspect, the present disclosure relates to a female connector for a relay with a housing. The female connector comprises a contact wall which is arranged in the housing, wherein the contact wall has a first deformation having at least one first contact elevation, and a spring tongue which is arranged in the housing, wherein the spring tongue faces the contact wall, wherein the spring tongue has a second deformation having a plurality of second contact elevations, wherein a second dip is formed between two successive second contact elevations, and wherein the second contact elevations are arranged opposite the at least one first contact elevation and are provided for pressing of contact pins of different contact pin lengths against the at least one first contact elevation in a sprung manner.

This has the technical advantage that contact pins of different dimensions, for example load and coil connections of a relay, can be held in the female connector.

The female connector is adapted with a housing in which a contact wall and a spring tongue opposite the contact wall are formed.

A receiving space into which a contact pin of a relay can be inserted is formed between the contact wall and the spring tongue. The contact wall has at least one first contact elevation and the spring tongue has a plurality of second contact elevations which function to contact the contact pin inserted into the receiving space of the female connector.

The spring tongue is suitable for exerting a spring force on the contact pin. If the contact pin is inserted into the receiving space of the female connector via a housing opening of the housing that adjoins the receiving space, the spring tongue is elastically deformed by the contact pin and consequently exerts a spring force on the inserted contact pin, whereby the contact pin between the contact wall and the spring tongue is pressed resiliently. The contact between the contact pin and the contact wall or between the contact pin and the spring tongue takes place exclusively via the plurality of first and second contact elevations formed on the contact wall and the spring tongue. The at least one first contact elevation is formed within a first deformation on a surface of the contact wall facing the spring tongue.

The at least one first contact elevation is adapted as a continuous elevation. The at least one first contact elevation faces the flexible tongue and points into the contact space between the contact wall and the flexible tongue.

The plurality of second contact elevations is formed within a second deformation on a surface of the spring tongue facing the contact wall as elevations separated from one another, and has a second dip between each two adjacent elevations. The second contact elevations are adapted as elevations, facing the contact wall and extend into the receiving space between the contact wall and the spring tongue.

The first and second contact elevations function to make electrical contact with the contact pin introduced into the receiving space of the female connector and are made of a conductive material. The first and second contact elevations are also able to hold the contact pin secured between the contact wall and the spring tongue by means of an elastic contact pressure based on the spring force of the spring tongue.

This achieves the technical advantage that, by means of the spring force of the spring tongue, a contact pin of a relay inserted into the female connector is held in the female connector via the first and second contact elevations contacting the contact pin thereby allowing for a secured plug connection and electrical contact between the female connector and the contact pin.

According to an example, the first deformation of the contact wall comprises a plurality of first contact elevations, wherein a first dip is formed between two successive first contact elevations, wherein a second dip is formed between two successive second contact elevations; and wherein the second contact elevations are arranged opposite the first contact elevations in pairs.

This achieves the technical advantage that the contacting of the contact pins through the contact wall and the spring tongue can be achieved via a discrete number of contacted first and second contact elevations.

The first contact elevations are formed as elevations that are separate from one another and have at least one dip formed between two adjacent contact elevations. The first contact elevations face the spring tongue and point into the contact space between the contact wall and the spring tongue.

According to an example, the contact wall has a first number of first contact elevations up to a first insertion depth of a first contact pin and a second number of first contact elevations up to a second insertion depth of a second contact pin, wherein the spring tongue to the first insertion depth of the first contact pin comprises the first number of second contact elevations and up to the second insertion depth of the second contact pin comprises the second number of second contact elevations, wherein the first number of the first contact elevations and the second contact elevations are provided for holding the first contact pin, and wherein the second number of the first contact elevations and the second contact elevations is provided for holding the second contact pin.

This has the technical advantage that the contact between the contact pin and the female connector and the holding of the contact pin in the female connector can be varied in discrete steps via the insertion depth of a contact pin inserted into the female connector according to the principles of the present disclosure.

If a contact pin is inserted into the female connector up to a first insertion depth, the contact pin contacts a first number of first contact elevations formed on the contact wall and a first number of second contact elevations formed on the spring tongue. In relation to the number of contacted first and second contact elevations, the inserted contact pin experiences a corresponding contact with the female connector and a contact force exerted on the contact pin by the contact wall and the spring tongue and is held in the female connector according to the first contact force.

If, on the other hand, a contact pin is inserted into the female connector up to a second insertion depth, the contact pin contacts a second number of first contact elevations formed on the contact wall and a second number of second contact elevations formed on the spring tongue and consequently experiences contact with the female connector, corresponding to the second number of first and second contact elevations contacted, and a second contact force and is held in the female connector according to the second contact force.

The insertion and extraction forces, the contact forces and the contact resistances of the plug connections for different contact pins can thus be varied step by step via the insertion depth and the associated number of contacted first and second contact elevations.

According to an example, a first contact force is exerted on a first contact pin via the first number of first contact elevations and via the first number of second contact elevations from the contact wall and the spring tongue, and wherein a second contact force is exerted on a second contact pin via the second number of first contact elevations and the second number of second contact elevations from the contact wall and the spring tongue.

This achieves the technical advantage that the contact force acting on the contact pin can be varied in discrete steps via the insertion depth of a contact pin inserted into the female connector and, associated therewith, via the number of first and second contact elevations contacted by the contact pin.

Via the spring force of the spring tongue, a contact force is exerted on the contact pin by means of the first and second contact elevations on the contact wall and the spring tongue contacted by the contact pin, with each of the number of contact elevations 1, . . . , n exerts an individual contact force FK1, . . . , FKn on the contact pin. The amounts of the individual contact forces depend on the deflection of the spring tongue by the contact pin and on the spring force exerted by the spring tongue.

The main component of the individual contact forces runs in a direction perpendicular to the respective surface of the contact pin and is oriented along the normal direction of the contact pin surface. The contact force FKges acting on the contact pin and the spring tongue from the contact wall thus has a proportionality to the number of the first and second contact elevations 1, . . . , n contacted by the contact pin and results from the sum of the individual contact forces FK1, . . . , FKn acting on the contact pin via the individual contacted contact elevations 1, . . . , n according to the following relationship:

F_{Kges}=F_{K1}+ . . . F_{Kn}.

A higher number of contact elevations contacted by the contact pin consequently leads to a higher contact force acting on the contact pin.

The technical advantage is also achieved that the different requirements with regard to the pulling and plugging forces of the load connections and the coil connections of a relay can be met via the insertion depth of the contact pin, since these are in direct relation to the contact forces acting on the contact pins.

According to an example, a first contact resistance occurs between the first number of first and second contact elevations and the first contact pin, and a second contact resistance occurs between the second number of first and second contact elevations and the second contact pin.

This achieves the technical advantage that the contact resistance occurring between the contact pin and the female connector can be varied in discrete steps via the insertion depth of a contact pin into the female connector and, associated therewith, via the number of first and second contact elevations contacted by the contact pin.

The contact resistance of two electrically conductive materials in contact with one another is inversely proportional to the contact force with which the two materials are pressed against one another.

According to Holm, the following relationship between contact resistance RK and contact force FK applies to almost spherical contact surfaces free of foreign layers:

$${R}_{k} ∼ \sqrt{\frac{1}{{F}_{K}}}$$

For the female connector, the contact resistance RKges results from the sum of the individual contact resistances RK1, . . . , RKn that occur on the individual contact elevations 1, . . . n, according to the following relationship:

$$\frac{1}{{R}_{{K}_{ges}}} = \frac{1}{{R}_{K 1}} + ⋯ + \frac{1}{{R}_{Kn}}$$

The contact resistance is inversely proportional to the number of contacted first and second contact elevations, so that with a plurality of contacted first and second contact elevations a smaller contact resistance occurs between the contact wall, the spring tongue and the contact pin, while with a comparatively small number of contacted first and second contact elevations a correspondingly larger contact resistance RKges occurs between the contact pin, the contact wall and the spring tongue.

According to an example, the housing has a first housing wall and a second housing wall arranged opposite the first housing wall, and a housing opening is defined between the first and second housing walls through which the respective contact pin can pass.

This has the technical advantage that the plug is given a structurally robust form via the housing. Furthermore, the dimensions of the female connector are defined via the housing. Furthermore, the technical advantage is achieved that the contact pin introduced into the female connector via the housing opening is arranged in a protected manner in the housing.

According to an example, the housing is formed as a cuboid hollow body.

According to an example, the housing is made from a sheet metal by means of a bending or folding process and has a welding point via which the bent or folded sheet metal ends are fixed to one another and via which the housing is given substantial structural strength.

This has the technical advantage of a simplified manufacture of the female connector.

According to an example, the second housing wall has, at the end of the second housing wall facing away from the housing opening, an elongated end region which extends beyond the corresponding end of the first housing wall.

This means that the connection and fastening area of the female connector can be adapted in a simplified manner as an elongated, bolt-shaped sheet metal. In addition, this has the technical advantage that the female connector is fixed in a structurally secured manner in a relay terminal via the elongated end region and can be electrically connected to it.

According to an example, the female connector comprises a contact clip which has a flat base section, a bent section connected to the base section and a bent-back bracket section a connected to the bent section, wherein the spring tongue is formed by the bent-back bracket section and is resiliently arranged opposite the flat base section.

This has the technical advantage that the spring tongue is arranged inside the housing and is suitable for exerting a spring force.

The contact clip is adapted as a base section, a bent section connected to the base section and a bent-back bracket section connected to the bent section. The bent-back bracket section is bent back in such a way that it runs almost parallel to the base section and is arranged within the housing. By means of the bent section which connects the base section and the bent-back bracket section to one another, the bent-back bracket section is resiliently movable with respect to the base section and is thus able to develop a spring force. The spring tongue, which is formed by the bent-back bracket section, is thus able to exert a spring force by means of which a contact pin inserted into the female connector can be elastically pressed between the spring tongue and the contact wall.

According to an example, the base section is formed on the second housing wall.

This has the technical advantage that the spring tongue is securely connected to the housing of the female connector.

Furthermore, a structural strength of the female connector and a configuration of the female connector that is as space-saving as possible is achieved by excluding additional connecting means between the spring tongue and the housing of the female connector.

According to an example, a resilient end of the spring tongue faces away from the housing opening.

By arranging the bent section of the contact clip in the direction of the housing opening, the insertion of a contact pin is facilitated, since a contact pin to be inserted is guided into the housing opening via the rounded area of the bent section.

According to an example, the resilient end of the spring tongue has an end section which inclines towards the base section.

According to an example, the end section of the spring tongue is adapted to contact the base section and to be pressed against it, and the end section is suitable for exerting a spring force.

The spring tongue is stiffened by the contact of the inclined end section with the base section and an increase in the spring force exerted by the spring tongue is achieved. This in turn increases the contact force exerted on a contact pin inserted into the female connector.

According to an example, the spring tongue is at least partially shaped like a wave.

This achieves the technical advantage of a simplified production of the plurality of second contact elevations of the spring tongue, in that the contact elevations can be achieved by correspondingly bending the spring tongue. Furthermore, it is achieved that the plurality of second contact elevations is formed in one piece on the spring tongue, which prevents contact elevations from being released from the spring tongue by repeated insertion and removal of contact pins in the female connector. Furthermore, due to the wave-shaped design of the spring tongue, the contact elevations have gently rising and falling flanks, which facilitate the introduction of contact pins and prevent the ends of the contact pins from tilting with the contact elevations.

According to an example, the at least one first contact elevation and/or the plurality of first contact elevations are formed in one piece on the contact wall as dips in the first housing wall by means of a stamping or stamping process.

This has the technical advantage of simplified production. Furthermore, it is achieved that the at least one first contact elevation and/or the plurality of first contact elevations is formed in one piece on the contact wall, which prevents contact elevations from being detached from the contact wall by repeated insertion and removal of contact pins in the female connector.

According to an example, the dips of the contact wall formed between the first contact elevations are flat.

This achieves a configuration of the contact wall that is as flat as possible, whereby a flat configuration of the first housing wall is also achieved. This contributes to the space-saving design of the female connector.

According to an example, the dips in the contact wall formed between the second contact elevations are formed on the first housing wall, in particular formed in a materially bonded manner.

This has the technical advantage that the contact wall is securely connected to the housing and thus has substantial structural strength. Furthermore, a space-saving design of the female connector is achieved in that additional connecting means between the contact wall and the first housing wall are excluded.

According to an example, the first contact elevations of the contact wall and the second contact elevations of the spring tongue are arranged one behind the other along an insertion direction of a contact pin.

This has the technical advantage that the number of first and second contact elevations contacted by the contact pin can be varied via the insertion depth of a contact pin into the female connector.

According to an example, the direction of insertion corresponds to the longitudinal direction of the contact wall and the spring tongue.

This has the technical advantage that the female connector can be adapted with the narrowest possible shape and thus as space-saving as possible.

According to an example, the first contact elevations are formed centrally on the contact wall in the transverse direction.

This has the technical advantage that contact can also be made with contact pins that are not inserted centrally into the female connector.

According to an example, the second contact elevations extend in the transverse direction over the entire width of the spring tongue.

This has the technical advantage that a contact pin inserted into the female connector is held securely in it and is kept from a tilting movement oriented about the longitudinal axis of the contact pin.

According to an example, the direction of insertion runs perpendicular to the axis of curvature of the bent section.

This has the technical advantage that a contact pin to be inserted is introduced into the housing opening via the curvature of the bent section.

According to an example, the contact wall and the spring tongue are made of electrically conductive material.

This achieves electrical contacting of the contact pin inserted into the female connector.

According to an example, the number of first contact elevations corresponds to the number of second contact elevations. This has the technical advantage that the first and second contact elevations can be arranged opposite one another in pairs. Furthermore, the identical number of first and second contact elevations enables a precise determination of the contact force acting on it based on the insertion depth of an inserted contact pin, in that the insertion depth is related to a corresponding number of contacted first and second contact elevations.

According to a further aspect, the present disclosure relates to a relay system with a relay which has a first contact pin and a second contact pin, a first female connector in which the first contact pin is inserted, and a second female connector in which the second contact pin is inserted.

This has the technical advantage that a relay system is provided, the load and coil connections of which can be securely connected to a female connector, which enables the insertion and withdrawal forces acting on the load and coil connections via the insertion depths of the contact pins of the load and coil connections to vary in discrete steps.

According to an example, the relay is a narrow relay, for example a relay with a width of 5 mm to 6 mm or 3 mm.

According to an example, the relay has a connection area which corresponds to a connection area of the relay terminal.

This enables a precisely fitting connection between the relay and the relay terminal.

According to an example, the first and second contact pins are fixed with the second contact pin end in a connection area of the relay.

According to an example, the female connector can be fixed with the elongated end area of the second housing wall in a connection area of a relay terminal.

This ensures that the female connector is securely fixed in the relay terminal.

According to an example, in a relay system the first contact pin is a coil connection and the second contact pin is a load connection of a relay.

This ensures that the load and coil connections of a relay can be connected by means of the female connector.

According to an example, the first and second contact pins are bar-shaped contact pins with a thickness that is uniform over their length and have a first contact pin end and a second contact pin end.

This ensures that the first and second contact pins each cause a uniform deflection of the spring tongue regardless of the insertion depth.

According to an example, the first and second contact pins are bar-shaped contact pins and have an isolated elevation.

This has the technical advantage of adapting the thickness.

According to an example, the first and second contact pins have tapered first contact pin ends.

This facilitates the insertion into the female connector.

According to an example, the first and/or second contact pins have taper-free first contact pin ends.

This has the technical advantage of a simplified manufacture of the contact pins of the coil connections.

According to an example, the second contact pins have tapered first contact pin ends and the first contact pins have taper-free first contact pin ends.

### BRIEF DESCRIPTION OF THE DRAWINGS

Further examples and implementations of the principles of the present disclosure are explained with reference to the accompanying figures. They show:

FIG. 1 is a schematic side sectional view of a female connector according to an example of the principles of the present disclosure;

FIG. 1A is a schematic side sectional view of a female connector according to a further example of the principles of the present disclosure along the sectional axis A in FIG. 2;

FIG. 2 is a schematic front view of the female connector according to an example of the principles of the present disclosure;

FIG. 3 is a schematic plan view of the female connector according to an example of the principles of the present disclosure;

FIG. 4 is a perspective schematic side view of the female connector according to an example of the principles of the present disclosure;

FIG. 5 is a schematic front view of the female connector according to example of the principles of the present disclosure, showing a first contact pin being inserted into the female connector;

FIG. 6 is a schematic side sectional view of the female connector according to an example of the principles of the present disclosure along the sectional axis B in FIG. 5, a first contact pin being inserted into the female connector;

FIG. 6A is a schematic side sectional view of the female connector according to a further example of the principles of the present disclosure, a first contact pin being inserted into the female connector;

FIG. 7 is a schematic front view of the female connector according to an example of the principles of the present disclosure, a second contact pin being inserted into the female connector;

FIG. 8 is a schematic side sectional view of the female connector according to an example of the principles of the present disclosure along the sectional axis C in FIG. 7, a second contact pin being inserted into the female connector;

FIG. 8A is a schematic side sectional view of the female connector according to a further example of the principles of the present disclosure, a second contact pin being inserted into the female connector;

FIG. 9 is a schematic front view of a relay system with a relay and a female connector according to an example of the principles of the present disclosure, the relay being plugged into a relay terminal;

FIG. 10 is a schematic side sectional view of the relay system and the relay terminal along the sectional axis A in FIG. 9;

FIG. 11 is an enlarged schematic side sectional view of the cutout area of the relay system in FIG. 10;

FIG. 12A is a schematic front view of the relay system with a relay and a female connector according to an example of the principles of the present disclosure, wherein the contact pins of the relay are not inserted into the female connectors;

FIG. 12B is a schematic side sectional view of the female connector along the sectional axis C in FIG. 12A;

FIG. 12C is a schematic side sectional view of the female connector along the sectional axis D in FIG. 12A;

FIG. 13A is a schematic front view of the relay system with a relay and a female connector according to an example of the principles of the present disclosure, wherein the contact pins of the relay are inserted into the female connectors;

FIG. 13B is a schematic side sectional view of the female connector along the sectional axis C in FIG. 13A;

FIG. 13C shows a schematic side sectional view of the female connector along the sectional axis D in FIG. 13A.

### DETAILED DESCRIPTION

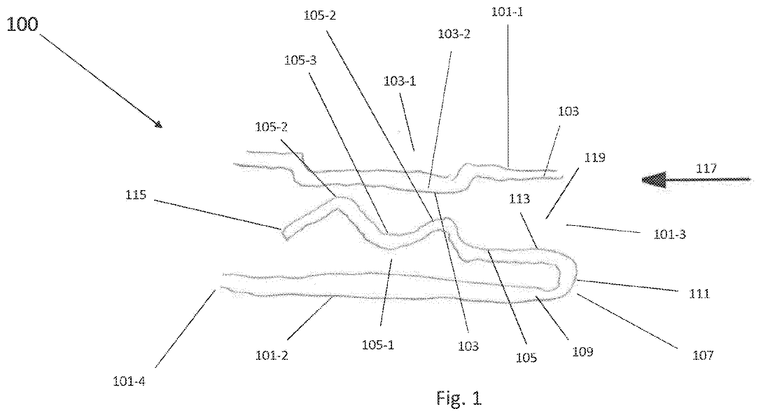

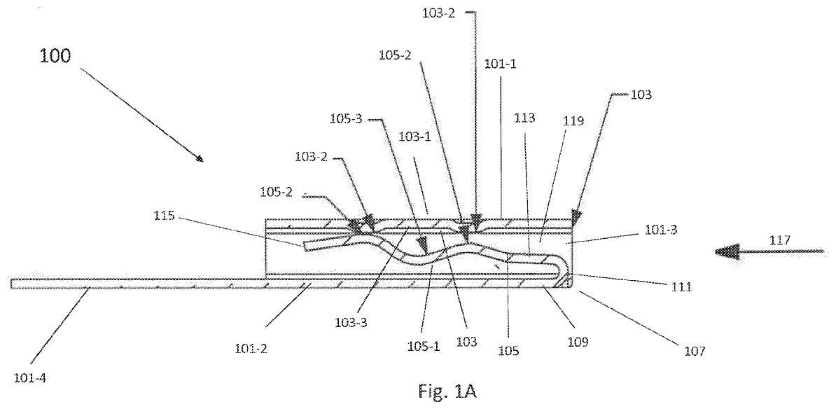

According to FIG. 1, a female connector 100 according to an example of the principles of the present disclosure comprises a housing 101, a contact wall 103 which is arranged in the housing 101, the contact wall 103 having a first deformation 103-1 with at least one first contact elevation 103-2, and a spring tongue 105, which is arranged in the housing 101, the spring tongue 105 facing the contact wall 103, the spring tongue 105 having a second deformation 105-1 with a plurality of second contact elevations 105-2, wherein a second dip 105-3 is formed between two successive second contact elevations 105-2, respectively, and wherein the second contact elevations 105-2 of the at least one first contact elevation 103-2 are arranged opposite to the at least one first contact elevation 103-2 and are provided for pressing of contact pins 501, 702 of different contact pin lengths against the first contact elevations 103-2 in a sprung manner.

According to FIG. 1, the first housing wall 101-1 has a contact wall 103 which is formed on the inside of the first housing wall 101-1. The contact wall 103 has at least one first contact elevation 103-2, which is arranged in a first deformation 103-1.

The at least one first contact elevation 103-2 is formed on the inside of the contact wall 103 as a cohesive elevation, facing the second housing wall 101-2 and extending along the insertion direction 117 of a contact pin.

In an example, the at least one first contact elevation 103-2 is formed in one piece on the contact wall 103 by the at least one first contact elevation 103-2 being embedded as dips in the first housing wall 101-1 by means of a stamping or embossing process.

FIG. 1A shows a further schematic sectional side view of the female connector 100 according to a further example.

According to FIG. 1A, the first deformation 103-1 of the contact wall has a plurality of first contact elevations 103-2, each formed on the inside of the contact wall 103 as a plurality of separated elevations and facing the second housing wall 101-2.

Furthermore, according to an example, the contact wall 103 has a plurality of first dips 103-3 which are arranged such that a first dip 103-3 is arranged between each two adjacent first contact elevations 103-2. The first dips 103-3 are each adapted as flat surfaces between the first contact elevations 103-2.

In FIGS. 1A to 13C, only two first contact elevations 103-2 and, accordingly, only one first dip 103-3 are shown. However, the present disclosure is not intended to be restricted to this; rather, a plurality of first contact elevations 103-2 and a plurality of first dips 103-3 are possible.

As can be seen in FIG. 1A, the first contact elevations 103-2 are formed one behind the other on the contact wall 103 along the insertion direction 117 of a contact pin.

The first deformation 103-1 of the contact wall 103 extends along the insertion direction 117 and includes all first contact elevations 103-2 and first dips 103-3 of the contact wall 103.

According to FIG. 1, the second housing wall 101-2, which is arranged opposite the first housing wall 101-1, has a contact clip 107 which has a base section 109 arranged plane-parallel to the first housing wall 101-1 and a bent section 111 adjoining the base section 109 and a bent-back bracket section 113 adjoining the bent section 111.

The bent-back bracket section 113 is arranged between the base section 109 and the first housing wall 101-1. The bent-back bracket section 113 is adapted as a spring tongue 105. The spring tongue 105 has a plurality of second contact elevations 105-2 and a plurality of second dips 105-3, which are arranged on a surface of the spring tongue 105 within a second deformation 105-1.

The second contact elevations 105-2 are formed as elevations on the surface of the spring tongue 105 facing the contact wall 103 and are facing the contact wall 103. The plurality of second contact elevations 105-2 are arranged one behind the other along the insertion direction 117, two adjacent second contact elevations 105-2 each being separated by a second dip 105-3 arranged between them.

The second deformation 105-1 of the spring tongue 105 extends along the insertion direction 117 and comprises all second contact elevations 105-2 and all second dips 105-3. The second deformation 105-1 is wave-shaped, so that the second contact elevations 105-2 as well as the second dips 105-3 are each formed with gently rising and falling edges and thus continuously merge into one another.

In each of FIGS. 1 to 13C, only two second contact elevations 105-2 and only one second dip 105-3 arranged between them are shown. However, the present disclosure is not intended to be restricted to this; rather, a multiplicity of second contact elevations 105-2 and a multiplicity of second dips 105-3 are also possible.

The at least one and/or the plurality of first contact elevations 103-2 is arranged on the contact wall 103 facing the spring tongue 105, while the plurality of second contact elevations 105-2 on the spring tongue 105 is arranged facing the contact wall 103. Both the first contact elevations 103-2 and the second contact elevations 105-2 thus extend into a receiving space 119 arranged between the contact wall 103 and the spring tongue 105. The plurality of first contact elevations 103-2 and the plurality of second contact elevations 105-2 are arranged in pairs opposite one another and facing one another.

The spring tongue 105 also has an end section 115 which is arranged on the resilient end of the spring tongue 105 opposite the bent section 111. The end section 115 is inclined towards the base section 109 of the contact clip 107 of the second housing wall 101-2.

In an example, the end section 115 of the spring tongue 105 is adapted to contact the base section 109 of the contact clip 107. In this way, the spring force exerted by the spring tongue 105 is increased.

The second housing wall 101-2 also has an elongated end region 101-4, which adjoins the end of the base section 109 of the contact clip 107 facing away from the bent section 111. The elongated end region 101-4 of the second housing wall 101-2 extends beyond the corresponding end of the opposite first housing wall 101-1.

Furthermore, the housing 101 of the female connector 100 has a housing opening 101-3 which communicates with the receiving space 119 arranged between the contact wall 103 and the spring tongue 105, and which is arranged between the bent section 111 of the contact clip 107 of the second housing wall 101-2 and the corresponding end the first housing wall 101-1.

The bent section 111 of the contact clip 107 of the second housing wall 101-2, whose axis of curvature is oriented perpendicular to the insertion direction 117 and to the longitudinal direction of the female connector 100, forms the lower boundary of the housing opening 101-3 and thus facilitates the insertion of a contact pin via the curved surface of the bent area via the housing opening 101-3 into the receiving space 119 arranged between the contact wall 103 and the spring tongue 105, in that the end of a contact pin to be inserted is guided via the curved surface of the bending region 111 into the receiving space 119.

As shown in FIG. 1, the insertion direction 117 corresponds to the longitudinal direction of the female connector 100.

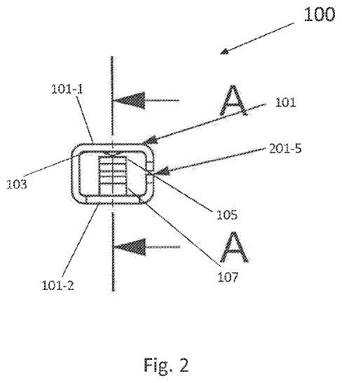

FIG. 2 shows a schematic front view of the female connector 100. The viewing direction in FIG. 2 is oriented against the insertion direction 117. As shown in FIG. 2, in an example the housing 101 of the female connector 100 is formed as a cuboid hollow body which is formed by means of a bending or folding process and has a weld point 201-5, by means of which the cuboid hollow body is connected to form a solid structure. The spring tongue 105 is formed via the spring clip 107 on the inside of the second housing wall 101-2 in the middle in the interior of the housing 101. Opposite the spring tongue 105, the at least one or the plurality of first contact elevations 103-2 is formed centrally on the contact wall 103. The vertical line and the two horizontal arrows define the cutting axis and the viewing direction of FIGS. 1 and 1A.

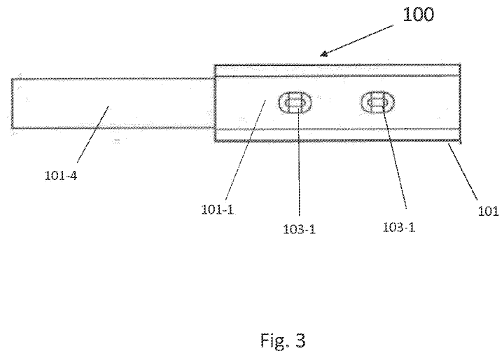

FIG. 3 shows a schematic plan view of the female connector 100 according to an example of the principles of the present disclosure. In an example, the first contact elevations 103-2 are cast into the first housing wall 101-1 as oval dips.

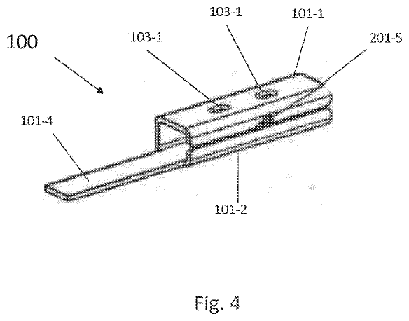

FIG. 4 shows a perspective schematic view of the female connector 100 according to an example of the principles of the present disclosure.

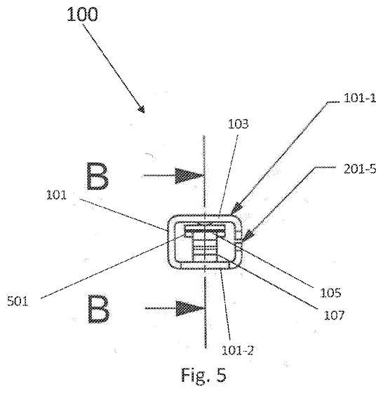

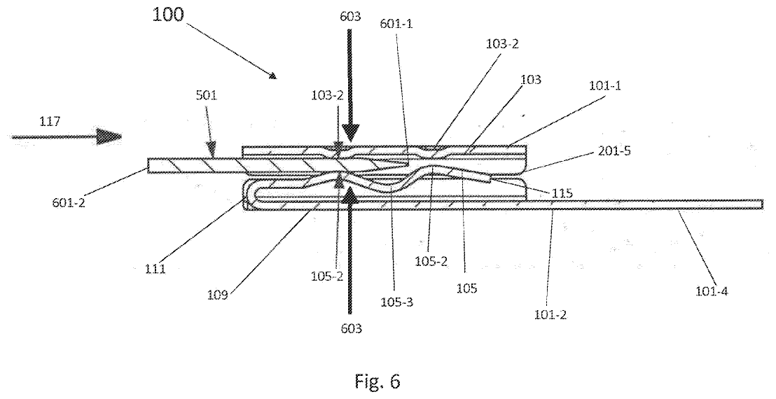

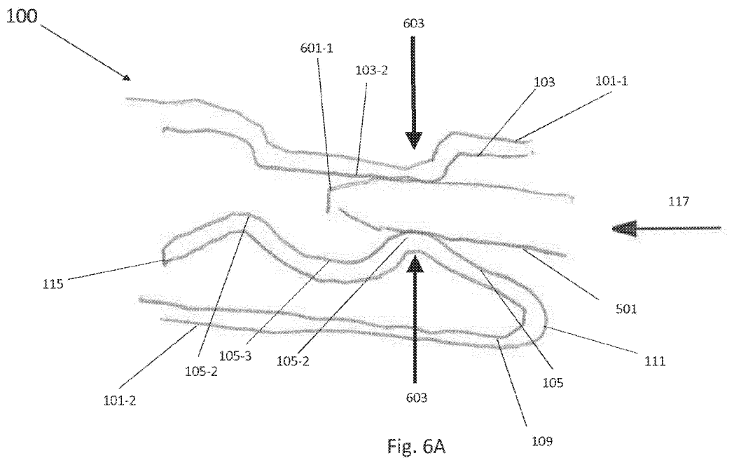

FIG. 5 shows a schematic front view of the female connector 100 into which a first contact pin 501 is inserted. The viewing direction in FIG. 5 is oriented against the insertion direction 117. The first contact pin 501 is pressed elastically between the spring tongue 105 and the contact wall 103. The vertical line and the two horizontal arrows define the cutting axis and the viewing direction in FIG. 6.

FIG. 6 shows a schematic side sectional view of the female connector 100 according to an example of the principles of the present disclosure, into which a first contact pin 501 is inserted up to a first insertion depth. In FIG. 6, the female connector 100 is shown according to an example with two first contact elevations 103-2.

According to FIG. 6, the first contact pin 501 is a rod-shaped contact pin and has a first contact pin end 601-1 and a second contact pin end 601-2. The first contact pin 501 is inserted with the first contact pin end 601-1 into the receiving space 119 between the contact wall 103 and the contact tongue 105 via the housing opening 101-3 along the insertion direction 117.

The first contact pin 501 is inserted into the female connector 100 up to a first insertion depth and makes contact with a first number of first and second contact elevations 103-2, 105-2. As shown in FIG. 6, the first number corresponds to only one of the two first contact elevations 103-2 of the contact wall 103 and to only one of the two second contact elevations 105-2 of the spring tongue 105. However, it is also conceivable that the first number corresponds to a different number of contacted first and second contact elevations 103-2, 105-2.

With the arrows running perpendicular to the longitudinal axis of the first contact pin 501, a first contact force 603 acts on the first contact pin 501 via the two first and second contact elevations 103-2, 105-2. The first contact force 603 results from the sum of the individual contact forces acting on the first contact pin 501 via the individual first and second contact elevations 103-2, 105-2, which are each represented by the two black arrows facing each other and run perpendicular to the longitudinal axis of the first contact pin 501, the length of the arrows symbolizing the amount of the individual contact forces.

FIG. 6A shows a schematic side sectional view of the female connector 100 according to a further example, wherein according to this example the first deformation 103-1 comprises the at least one first contact formation 103-2, and a first contact pin 501 is inserted into the female connector 100.

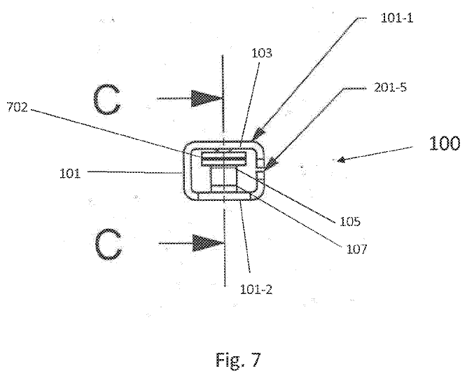

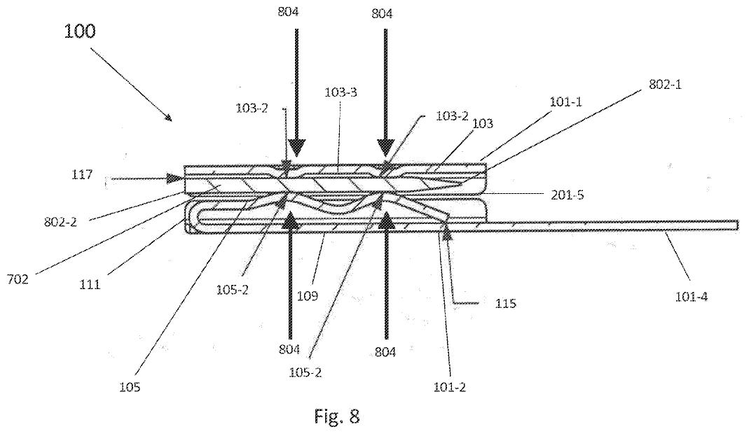

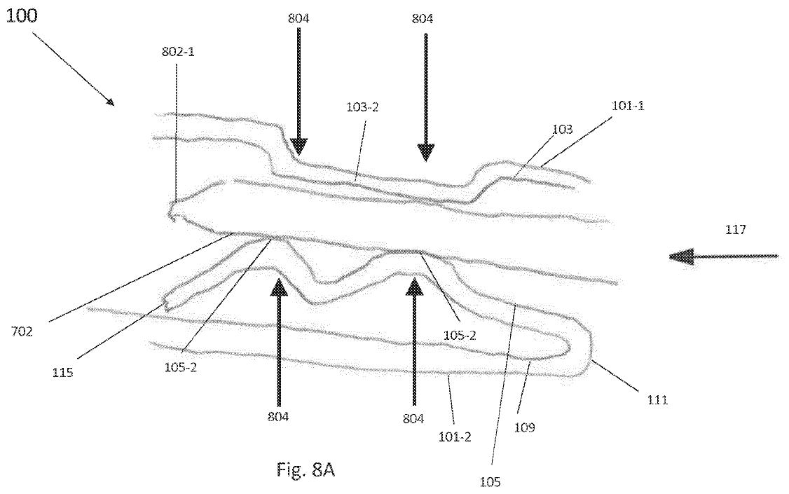

FIG. 7 shows a schematic front view of the female connector 100 into which a second contact pin 702 is inserted. The viewing direction in FIG. 7 is oriented against the insertion direction 117. The second contact pin 702 is pressed elastically between the spring tongue 105 and the contact wall 103. The vertical line and the two horizontal arrows define the cutting axis and the viewing direction in FIG. 8.

FIG. 8 shows a schematic side sectional view of the female connector 100 according to an example of the principles of the present disclosure, into which a second contact pin 702 is inserted up to a second insertion depth. In FIG. 8, the female connector 100 is shown according to an example with two first contact elevations 103-2.

As can be seen in FIG. 8, the second contact pin 702 is likewise a rod-shaped contact pin and has a first contact pin end 802-1 and a second contact pin end 802-2.

The second contact pin 702 is inserted with the first contact pin end 802-1 into the receiving space 119 between the contact wall 103 and the contact tongue 105 via the housing opening 101-3 along the insertion direction 117.

The second contact pin 702 is, however, inserted into the female connector 100 to a greater second insertion depth and thus contacts a greater second number of first and second contact elevations 103-2, 105-2. In the present case, the second number corresponds to the two first contact elevations 103-2 of the contact wall 103 and the two second contact elevations 105-2 of the spring tongue 105. However, it is also conceivable that the second number corresponds to a different number of contacted first and second contact elevations 103-2, 105-2.

The second contact force 804 acting on the second contact pin 702 inserted up to a second insertion depth into the female connector 100 results from the sum of the number of individual contact forces exerted on the contacted first contact elevations 103-2 of the contact wall 103 and the number of individual exerted on the contacted second contact elevations 105-2 of the spring tongue 105 and are indicated by the four parallel oriented and mutually facing vertical arrows. The second contact force 804 acting on the second contact pin 702 inserted up to the second insertion depth is accordingly greater than the first contact force 603 acting on the first contact pin 702 inserted up to the first insertion depth.

FIG. 8A shows a schematic side sectional view of the female connector 100 according to a further example, wherein, according to this example, the first deformation 103-1 has at least a first contact formation 103-2, and a second contact pin 702 is inserted into the female connector 100.

As shown in FIGS. 6, 6A, 8 and 8A, the first and second contact pins 501, 702 according to an example each have tapered first contact pin ends 601-1, 802-1.

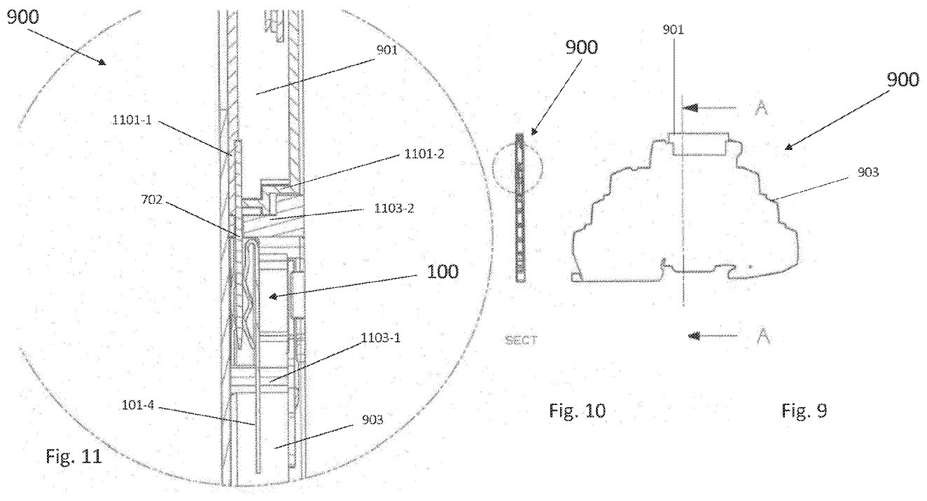

FIG. 9 shows a schematic front view and FIGS. 10 and 11 which each show a schematic side sectional view of a relay system 900 with a relay 901, which has a first contact pin 501 and a second contact pin 702, a first female connector 100 in which the first contact pin 501 is inserted, and a second female connector 100 in which the second contact pin 702 is inserted, the relay being plugged into a relay terminal 903. The vertical line shown in FIG. 9 and the two horizontal arrows define the cutting axis and the viewing direction of FIGS. 10 and 11.

According to FIG. 11, according to an example, the relay 901 is a narrow relay, preferably a relay with a width between 6 mm and 3 mm. Furthermore, the relay 901 has a connection area 1101-2, which corresponds to a connection area 1103-2 of the relay terminal 903 such that a precisely fitting connection of the relay 901 to the relay terminal 903 is made possible.

According to an example, the second contact pin 702 is fixed with the second contact pin end 802-2 in a connection area 1101-1 of the relay 901. Furthermore, in a connected state of relay 901 and relay terminal 903, the second contact pin 702 is inserted with the first contact pin end 702-1 into the female connector 100 up to a second insertion depth.

According to an example, the female connector 100 is fixed with the elongated end area 101-4 of the second housing wall 101-2 in a connection area 1103-1 of the relay terminal 903.

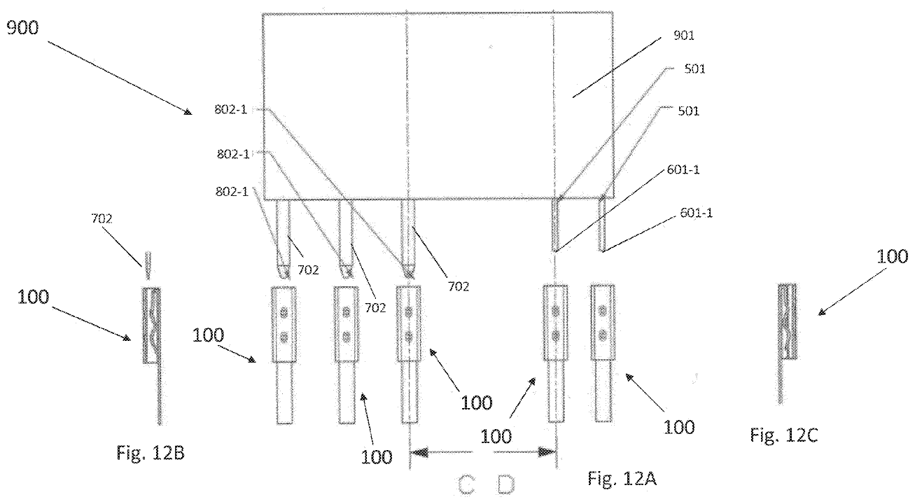

FIG. 12A shows a schematic front view of a relay system 900 with a relay 901 and a female connector 100 according to an example of the principles of the present disclosure, wherein the contact pins of the relay 901 are not inserted into the female connector 100. The vertical lines and the two horizontal arrows define the cutting axes and the viewing directions of FIGS. 12B and 12C.

According to an example, the first contact pins 501 of the relay 901 are coil connections and the second contact pins 702 are load connections of the relay 901. As can be seen in FIG. 12A, according to an example, the second contact pins 702 as load connections are adapted substantially wider and longer than the first contact pins 501 as coil connections.

Furthermore, according to an example, the second contact pins 702 have tapered first contact pin ends 702-1, while the first contact pins 501 have first contact pin ends 501-1 without tapering as coil connections.

FIGS. 12B and 12C show schematic side sectional views of the female connectors of the relay system 900.

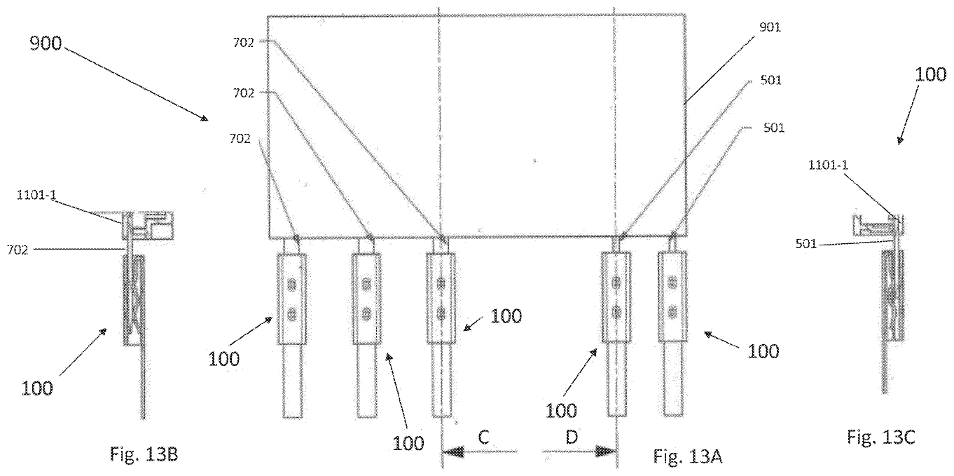

FIG. 13A shows the relay system 900 with a female connector 100 from FIG. 12A in a connected state.

The two first contact pins 501 as coil connections of the relay 901 are, as can be seen in FIG. 13B, inserted up to a first insertion depth into the female connector 100 and the three second contact pins 702 as load connections of the relay 901 are, as can be seen in FIG. 13C, are inserted into female connector 100 to a second insertion depth.

### LIST OF REFERENCE NUMBERS

100 female connector
101 housing
101-1 first housing wall
101-2 second housing wall
101-3 housing opening
101-4 elongated end region
103 contact wall
103-1 first deformation
103-2 first contact elevation
103-3 first dip
105 spring tongue
105-1 second deformation
105-2 second contact elevation
105-3 second dip
107 contact clip
109 base section
111 bent section
113 bent-back bracket section
115 end section
117 insertion direction
119 receiving space
201-5 welding point
501 first contact pin
601-1 first contact pin end
601-2 second contact pin end
603 first contact force
702 second contact pin
802-1 first pin end
802-2 second pin end
804 second contact force
900 relay system
901 relay
903 relay terminal
1101-1 connection area
1101-2 connection area
1103-1 connection area
1103-2 connection area

What is claimed is:

1. A female connector for a relay, comprising:
a housing;
a contact wall arranged in the housing, wherein the contact wall has a first deformation having at least one first contact elevation; and
a spring tongue arranged in the housing, wherein the spring tongue faces the contact wall, wherein the spring tongue has a second deformation having a plurality of second contact elevations, wherein a second dip is formed between two successive second contact elevations, and wherein the second contact elevations are arranged opposite the at least one first contact elevation and are configured to press contact pins of different contact pin lengths against the at least one first contact elevation in a sprung manner.

2. The female connector according to claim 1, wherein the at least one first contact elevation of the first deformation of the contact wall comprises a plurality of first contact elevations, wherein a first dip is formed between two successive first contact elevations, and wherein the second contact elevations are arranged opposite the first contact elevations in pairs.

3. The female connector according to claim 2, wherein the contact wall has a first number of the first contact elevations up to a first insertion depth of a first contact pin and has a second number of the first contact elevations up to a second insertion depth of a second contact pin, wherein the spring tongue to the first insertion depth of the first contact pin comprises the first number of the second contact elevations and up to the second insertion depth of the second contact pin comprises the second number of the second contact elevations, wherein the first number of the first contact elevations and the first number of the second contact elevations are configured to hold the first contact pin, and wherein the second number of the first contact elevations and the second number of the second contact elevations are configured to hold the second contact pin.

4. The female connector according to claim 3, wherein a first contact force is exerted on the first contact pin via the first number of the first contact elevations and via the first number of the second contact elevations from the contact wall and the spring tongue, and wherein a second contact force is exerted on the it second contact pin via the second number of the first contact elevations and via the second number of the second contact elevations from the contact wall and the spring tongue.

5. The female connector according to claim 3, wherein a first contact resistance occurs between the first number of the first contact elevations and the first number of the second contact elevations and the first contact pin, and a second contact resistance occurs between the second number of the first contact elevations and the second number of the second contact elevations and the second contact pin.

6. The female connector according to claim 2, wherein the housing has a first housing wall and a second housing wall arranged opposite the first housing wall, and wherein a housing opening is defined between the first housing wall and the second housing wall such that the respective contact pins are configured to pass through the housing opening.

7. The female connector according to claim 6, wherein the second housing wall has, at an end of the second housing wall and facing away from the housing opening, an elongated end region which extends beyond a corresponding end of the first housing wall.

8. The female connector according to claim 6, further comprising a contact clip having a flat base section, a bent section connected to the base section, and a bent-back bracket section connected to the bent section, wherein the spring tongue is formed by the bent-back bracket section and is resiliently arranged opposite the flat base section.

9. The female connector according to claim 8, wherein the base section is formed on the second housing wall.

10. The female connector according to claim 9, wherein a resilient end of the spring tongue faces away from a housing opening.

11. The female connector according to claim 10, wherein the resilient end of the spring tongue has an end section which inclines towards the base section.

12. The female connector according to claim 11, wherein the end section of the spring tongue is adapted to contact and press against the base section, and wherein the end section is configured to exert a spring force.

13. The female connector according to claim 2, wherein the first dip of the contact wall formed between the first contact elevations are integrally formed at a first housing wall.

14. The female connector according to claim 2, wherein the spring tongue is at least partially shaped like a wave.

15. The female connector according to claim 2, wherein the first dip of the contact wall formed between the first contact elevations is flat.

16. The female connector according to claim 2, wherein the first contact elevations of the contact wall and the second contact elevations of the spring tongue are arranged one behind the other along an insertion direction of the contact pin.

17. The female connector according to claim 16, wherein the insertion direction runs perpendicular to an axis of curvature of a bent section connected to the base section.

18. The female connector according to claim 2, wherein the contact wall and the spring tongue are made of electrically conductive material.

19. The female connector according to claim 2, wherein a number of first contact elevations is equal to a number of second contact elevations.

20. A relay system, comprising:
a relay comprising a first contact pin and a second contact pin;
a first female connector into which the first contact pin is inserted; and
a second female connector into which the second contact pin is inserted;
wherein each of the first female connector and the second female connector comprises:
a housing;
a contact wall arranged in the housing, wherein the contact wall has a first deformation having at least one first contact elevation; and
a spring tongue arranged in the housing, wherein the spring tongue faces the contact wall, wherein the spring tongue has a second deformation having a plurality of second contact elevations, wherein a second dip is formed between two successive second contact elevations, and wherein the second contact elevations are arranged opposite the at least one first contact elevation and are configured to press the respective first contact pin or the respective second contact pin against the at least one first contact elevation in a sprung manner.

21. The relay system according to claim 20, wherein the first contact pin is a coil connection and the second contact pin is a load connection of the relay.

22. The relay system of claim 20, wherein the first contact pin and the second contact pin have tapered first contact pin ends.

23. The relay system according to claim 20, wherein the first contact pin and the second contact pin have taper-free first contact pin ends.
